(19) United States
(12) Patent Application Publication
(10) Pub. No.: US 2001/0049950 A1
(43) Pub. Date: Dec. 13, 2001

(54) Electrical panel lock with locking plug head

(76) Inventor: Glyn A. Finch, Simpsonville, SC (US)

Correspondence Address: BANNER & WITCOFF, LTD., TEN SOUTH WACKER DRIVE, SUITE 3000, CHICAGO, IL, 60606, US

(21) Appl. No.: 09/859,922

(22) Filed: May 17, 2001

Related U.S. Application Data
(60) Provisional application No. 60/205,398, filed on May 19, 2000.

(51) Int. Cl. F16C 3/00; G05G 5/00

(52) U.S. Cl. 70/208

(57) ABSTRACT

A panel lock includes a housing with a pivotal face plate arranged to engage a bolt upon pivotal movement of the face plate. A rotatable plug assembly may be rotated between a locking and unlocking position to restrain or release the push plate.

### BACKGROUND OF THE INVENTION

In a principal aspect the present invention relates to a plug lock and more particularly, a flush mounted plug lock or panel lock which may be snapped into a recess of a panel door and which includes a projecting bolt cooperative with a strike to retain the door in a closed and locked position.

Various prior art patents disclose panel locks which are used to close and lock panels such as cabinet panels, locker door panels and the like. For example, U.S. Pat. No. 4,882,919 for a Flush Mounted Panel Lock Construction discloses such a mechanism. Other patents disclosing such mechanisms include U.S. Pat. No. 6,023,953 for a Slam Latch With Opposing Slides and U.S. Pat. No. 4,578,968 for a Flush Mount Lock Assembly. Typically, such locks include a pivotal face plate which is mounted for rotation about a pin or axis in the lock housing. A rotatable key actuated plug assembly actuates a lock plate provided for engagement with the face plate to lock or release the face plate. When the assembly plate is released pivoting action of the plate effects release of a bolt. When the plug lock is in the locked position, the face plate may not be pivoted and, thus, the bolt may not be disengaged from a strike.

Such locks are very popular. They generally work quite well. However, there remains the need for a simplified panel lock construction having a minimum number of parts and which may be used to efficiently lock a panel or door in a closed position.

### SUMMARY OF THE INVENTION

Briefly, the present invention comprises a panel lock which includes a housing with a cavity having a face plate pivotally mounted therein for engagement with a slidable bolt upon pivotal movement of the face plate. A rotatable plug lock assembly in the housing includes a plug with a partially circumferential flange that may be aligned over ribs in the face plate to thereby engage and hold the face plate in the housing and preclude pivotal movement of the face plate. The plug may be rotated to a position where the flange is removed from engaging the face plate ribs so that the face plate may be pivoted about its mounting axis to release the bolt from a strike.

Thus, it is an object of the invention to provide an improved panel lock construction.

It is a further object of the invention to provide a panel lock construction having a minimum number of parts wherein a pivotal face plate or lock plate may be engaged and locked by a rotatable key actuated plug lock assembly mounted in the housing for the lock.

Yet another object of the invention is to provide an inexpensive, yet rugged and durable, panel lock. These and other objects, advantages and features of the invention will be set forth in the detailed description which follows.

### BRIEF DESCRIPTION OF THE DRAWINGS

In the detailed description which follows, reference will be made with the drawing, comprised of the following figures:

FIG. 1 is an exploded isometric view of the panel lock;

FIG. 2 is a side elevation of the assembled panel lock depicted in FIG. 1;

FIG. 3 is a cross sectional view of the panel lock of FIG. 2 taken along the line 3-3 in FIG. 2;

FIG. 4 is a top or front plan view of the panel lock;

FIG. 5 is a cross-sectional view of the lock of FIG. 4 taken along the line 5-5;

FIG. 6 is a sectional view of the lock of FIG. 4 taken along the line 6-6;

FIG. 7 is an isometric view of the plug for the panel lock;

FIG. 8 is an isometric view of the panel lock with the push plate moved to the bolt unlocking position;

FIG. 9 is a plan view of the lock with the plug in the locked position;

FIG. 10 is a cross-sectional view of the lock of FIG. 9 taken along the line l0-l0; and

FIG. 11 is an exploded isometric view of an alternate construction; and

FIG. 12 is an isometric view of the construction of FIG. 11 assembled.

### DESCRIPTION OF THE PREFERRED EMBODIMENT

Referring to the Figures, the panel lock includes a housing 10 with a recess or cavity 12. The chamber or cavity 12 includes spaced, opposed, generally parallel sides or sidewalls 14 and 16. Each of the sides 14 and 16 include inside pivot pin openings such as pin opening 22 for receipt of a mounting pin 24 which is provided to pivotally mount a face plate 26 having a configuration generally congruent with the opening of cavity 12. A slidable bolt 28 is mounted in the cavity 12 and is biased by a spring 30 which fits into a bore 32 in bolt 28 to bias the bolt 28 outwardly from cavity 12 through a lateral or side opening 34 in the wall 14 of housing 10.

The housing 10 further includes a generally cylindrical bore or counterbore cavity 18 for receipt of a rotatable plug assembly or lock plug 20. The plug 20 is rotatably mounted in the counterbore cavity 18 and includes a plug head 36 which has opposite, outwardly extending arcuate sides 38 and 40 comprising a flange. The plug head 36 further includes opposite flat sides 42 and 44 connecting the arcuate sides 38, 40. In other words, the face plate 36, which ordinarily may be circular in shape, has sectors removed from the circular face plate 36 resulting in flat sides 42 and 44 that connect the partial peripheral, flange sides or sections 38 and 40.

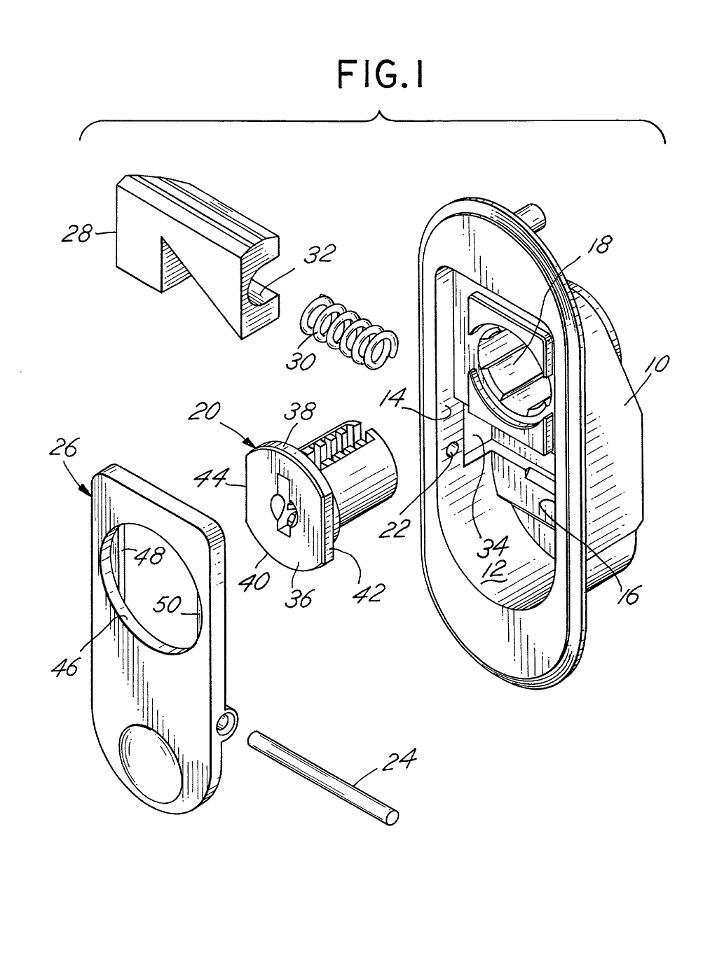

The face plate 26 includes a generally circular counterbore 46 with first and second underlying spaced, opposite side ribs or flanges 48 and 50 provided on the bottom side of the face plate 26 in the counter bore 46. Face plate 26 further includes a cam 51 (already used in FIG. 1) on its underside which may be engaged with an inclined follower surface 52 (not shown) of the bolt 28 so that when the push plate 26 is pivoted by pushing on a push surface about the pin 24, the cam 51 will engage the follower surface 52 (not shown) and translate the bolt 28 inwardly into housing 10 in the direction of the arrow in FIG. 3 against the biasing force of the biasing member or spring 30.

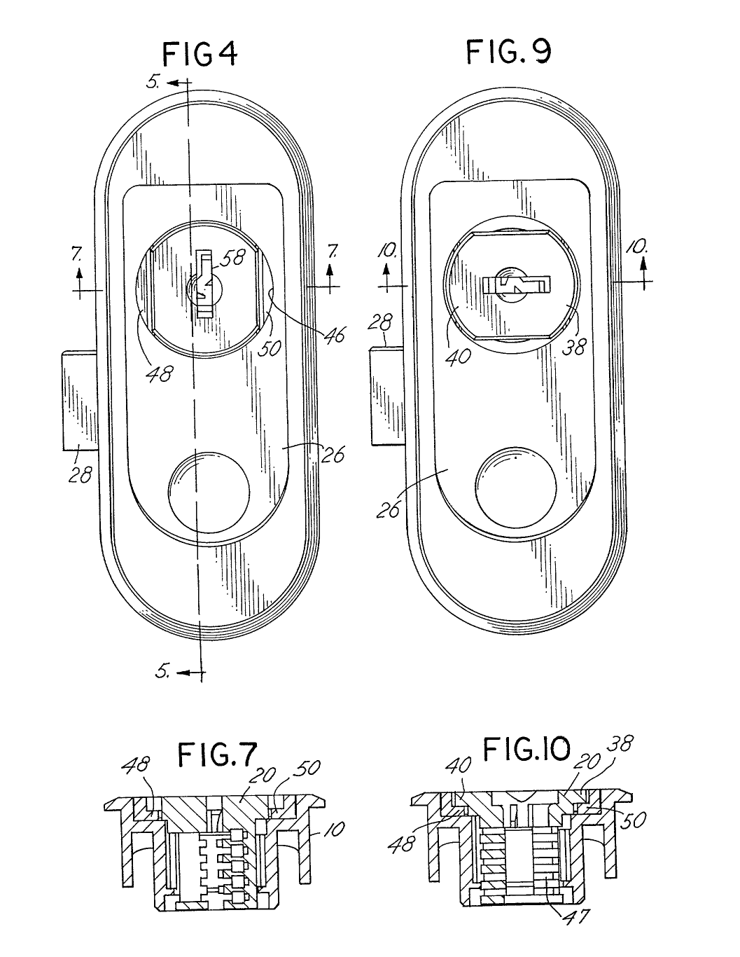

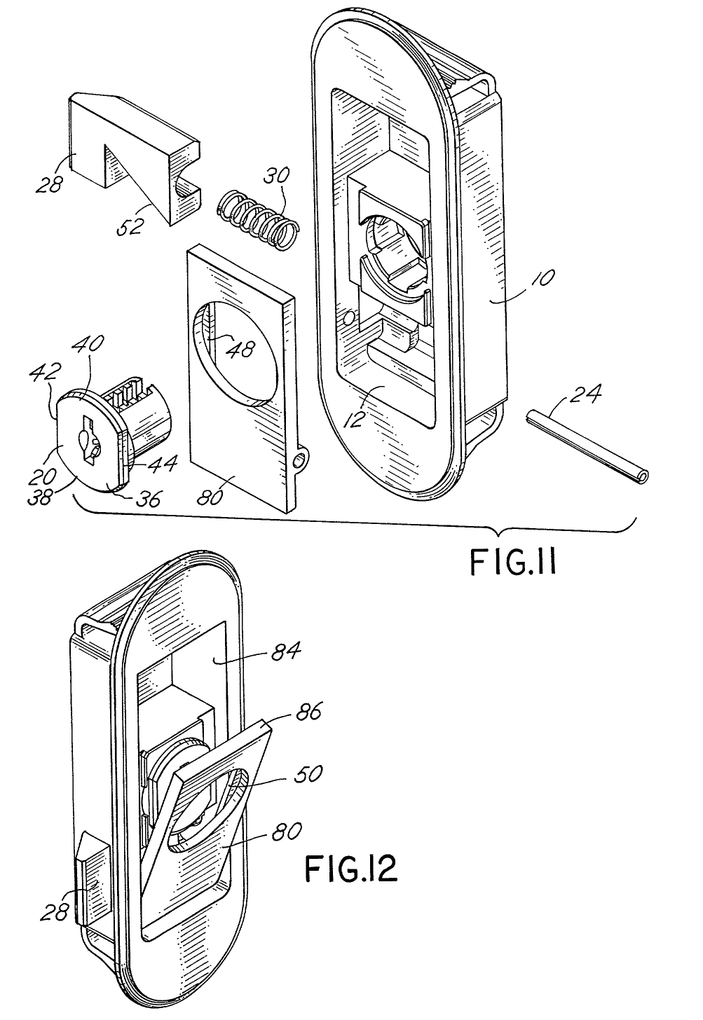

An important feature of the invention relates to the construction of the head face 36 and the opening 46 through the face plate 26. Thus, the ribs 48 and 50 of the face plate 26 underlie the arcuate flanges 38 and 40 of the plug head 36 of the plug 20 whenever the plug 20 has been rotated about a plug axis 45 to a locked position such as indicated in FIG. 9. Referring to FIG. 9 and FIG. 10, the ribs 48 and 50 underlie the flanges or flange sections 38 and 40 of plug head 36 when the rotatable plug assembly or lock plug 20 is rotated to the locked position and the face plate 26 is in the locked position with respect to the bolt 28. In order to release the face plate 26 and permit rotation thereof about the pin 24, a key 49 is inserted through a keyhole slot 58 to align tumblers 47 of the plug 20 permitting rotation of the rotatable plug assembly. The plug 20 is thus released from locking engagement with the bore 18 and then may be rotated to the position depicted in FIG. 4. When in this position as also depicted in FIG. 11, the ribs 48 and 50 no longer engage with the flanges 38 and 40. The push plate 26 may then be pushed or pivoted as depicted in FIG. 8 to drive the bolt 28 to the open position.

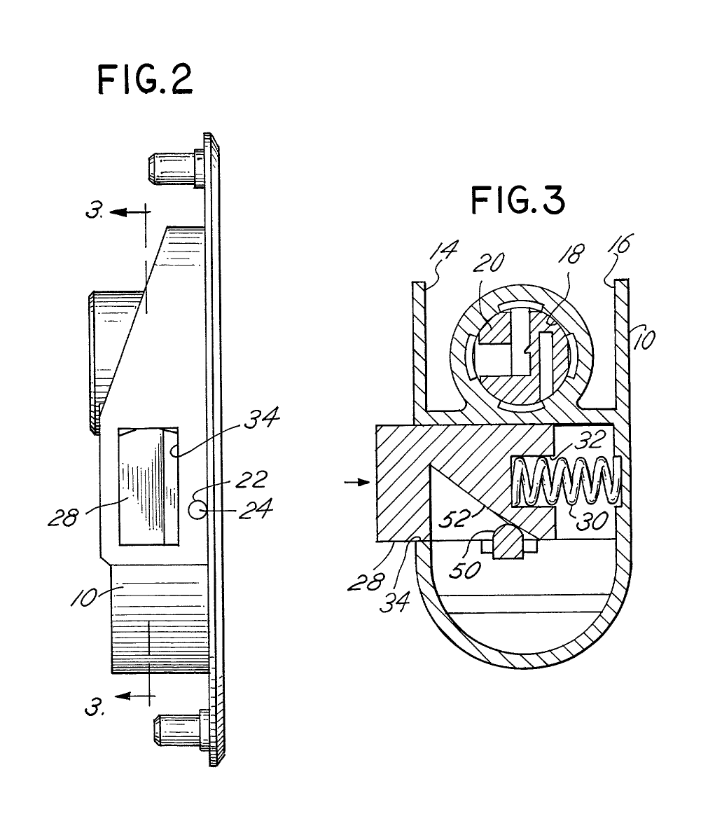

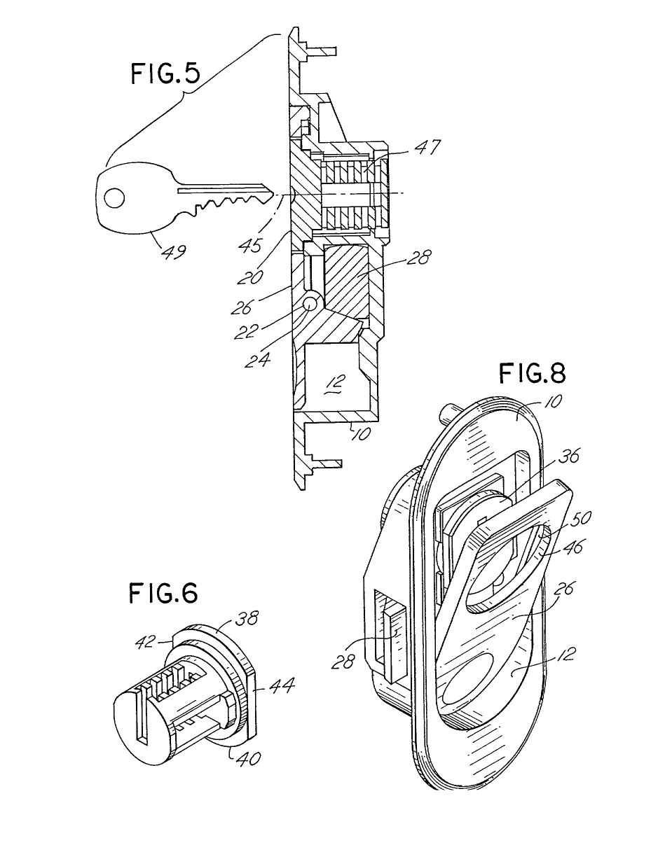

FIGS. 11 and 12 depict an alternative embodiment wherein a face plate 80 may be pulled to release a bolt. Like components of the embodiments have like numbers. The embodiment of FIGS. 11-12 differs from that of FIGS. 1-10 inasmuch as plate 80 is shortened so that it may be pulled rather than pushed to pivot and thereby move the bolt 28. Thus a finger cavity 84 is provided in the housing 10 so that an operator may engage an edge 86 of pivotal, shortened plate or pull 80.

It is possible to alter the construction of the cooperating flanges associated with the plug head 36 and the opening 46 of the face plate 26 to accomplish the described result. Various other modifications may be made to the panel lock without departing from the spirit and scope of the invention. The invention is therefore to be limited only by the following claims and equivalents thereof.

1. A panel lock comprising, in combination:
a housing including a cavity having opposite sides and a front face opening accessing the cavity;
a face plate generally congruent with the housing opening, said face plate positioned in the opening and including opposite sides pivotally attached to the opposite sides respectively of the housing cavity for pivotal movement about an axis extending between the opposite sides for movement between a locking position and an unlocking position;
a bolt slidably mounted in the housing cavity and projecting through a passage in the side of the cavity to engage a strike, said bolt slidable into the housing in response to pivoting of the push late about the axis to the unlocking position; and
a rotatable plug assembly in the housing, said rotatable plug assembly including a plug head with a partially circumferential flange and a key slot for receipt of a key to actuate the rotatable plug assembly;
said face plate having an opening for receiving the plug head, said opening including two underlying spaced, opposite side ribs which underlie the plug head flange when the rotatable plug assembly and face plate are both in their locking position.

2. The panel lock of claim 1 including a biasing member in the cavity for biasing the bolt to the locking position.

3. The panel lock of claim 2 further including a cam actuator on the face plate and a follower on the bolt, said cam actuator engaging the follower to translate the bolt to the unlocking position by pivotal movement of the face plate.

4. A panel lock comprising, in combination:
a housing with a cavity, said cavity including a front opening with opposite sides;
a key actuated plug assembly rotatably mounted in the housing, said plug assembly including a plug head having a partially circumferential peripheral flange;
a bolt slidably mounted in the cavity and extendable through a side of the housing to engage a strike;
a biasing member in the cavity for engaging the bolt and biasing the bolt outwardly from the housing to engage a strike; and
a face plate pivotably mounted in the front opening of the cavity, said face plate including a passage therethrough for the plug head, said passage including a which underlie the plug head plate flange when the face plate is positioned in the cavity opening with the plug head opening surrounding the plug head and the lock plug is in the locking position.
